(19) United States
(12) Patent Application Publication
(10) Pub. No.: US 2011/0234784 A1
(43) Pub. Date: Sep. 29, 2011

(54) DISPLAY DEVICE, DISPLAY METHOD, PROGRAM, AND RECORDING MEDIUM

(75) Inventor: Yoichi Sugino, Osaka (JP)

(73) Assignee: PANASONIC CORPORATION, Osaka (JP)

(21) Appl. No.: 13/052,448

(22) Filed: Mar. 21, 2011

(30) Foreign Application Priority Data
Mar. 23, 2010 (JP) 2010-066038
Dec. 21, 2010 (JP) 2010-283908

(51) Int. Cl. H04N 7/18

(52) U.S. Cl. 348/77; 348/E07.085

(57) ABSTRACT

A display device is proposed that can encourage a user to frequently turn on and off the display device. The display device includes: a video signal display unit 110 acting as a display for displaying video; a camera unit 160 acting as an imaging device for generating image data by imaging; an image recognition unit 170 acting as a detector for detecting a viewer in an image of the image data generated by the camera unit 160; a measuring device for measuring a non-viewing time during which the video signal display unit 110 displays video and the image recognition unit 170 detects no viewers; and a viewing information managing unit 180 acting as a recording device for recording the measured time.

### FIELD OF THE INVENTION

The present invention relates to a display device that can present a viewing state of video displayed on the display device in terms of power saving.

### BACKGROUND OF THE INVENTION

In recent years, power consumption has been reduced in various electrical apparatuses in response to growing environmental awareness. For example, in addition to power savings in the components of electrical apparatuses, many electrical apparatuses have the function of entering an operation mode with reduced power consumption, that is, a power saving state or a standby state when a user does not issue any commands for a certain period of time.

Under these circumstances, Japanese Patent No. 3862027 (hereinafter, will be called a patent document) discloses a broadcast signal receiving system (television) for efficiently controlling power savings.

FIG. 13 is a block diagram showing the overall configuration of the broadcast signal receiving system disclosed in the patent document. In FIG. 13, a tuner unit 11 for receiving television broadcasting receives television broadcast waves from an input terminal 11a. The output side of the tuner unit 11 is connected to a video decoder 12 for converting a digital video signal to an analog video signal and an audio decoder 13 for converting a digital audio signal to an analog audio signal. An on-screen display (OSD) circuit 14 superimposes various display signals, which include a channel number, on the analog video signal outputted from the video decoder 12. The analog video signal outputted from the OSD circuit 14 is inputted to a television monitor 15 through a video input terminal 15a and is displayed thereon. The analog audio signal outputted from the audio decoder 13 is inputted to the television monitor 15 through an audio input terminal 15b.

A control unit 18 includes a CPU, ROM, and RAM, which are not shown, and controls the tuner unit 11, the video decoder 12, the audio decoder 13, and the OSD circuit 14.

A key input unit 21 notifies the control unit 18 of the output of operation information about the operations of buttons on a device of the broadcast signal receiving system described in the patent document and a key operation signal received by a receiving unit 22 from a remote control 23. A camera unit 25 is provided on the device of the broadcast signal receiving system described in the patent document, and the camera unit 25 is installed so as to image a viewer. The signal of the image captured by the camera unit 25 is inputted to a personal identification unit 26. The personal identification unit 26 detects a face image from the captured image, performs personal identification for identifying a viewer based on the detected face image, and decides whether the eyes of the viewer are opened or closed. The personal identification unit 26 notifies the control unit 18 of the input of a signal indicating an identification result and an open/closed state of the eyes.

A clock unit 28 notifies the control unit 18 of the current time. A timer circuit unit 29 is operated by a command of the control unit 18 and measures a predetermined time.

A recording/reproducing apparatus 40 records a broadcast signal on a recording medium, e.g., a hard disk drive and a DVD and reproduces the broadcast signal recorded on the recording medium. The recording and reproduction of the recording/reproducing apparatus 40 are controlled by the control unit 18.

In the broadcast signal receiving system configured thus, when the remote control 23 is operated to turn on a television, which is the broadcast signal receiving system, the broadcast signal received by the tuner unit 11 passes through the video decoder 12, the audio decoder 13, and the OSD circuit 14 under the control of the control unit 18 and a television program specified by the remote control 23 is displayed on the television monitor 15. The control unit 18 controls the recording/reproducing apparatus 40 to start time-shifting recording, allowing later viewing of video recorded while a viewer is away from the television monitor 15, which will be described later. Further, the control unit 18 instructs the camera unit 25 to start imaging. An image captured by the camera unit 25 undergoes image recognition in the personal identification unit 26. In the personal identification unit 26, the presence or absence of a face is detected, personal identification is performed to identify the face, and an open/closed state of eyes is obtained. The face detection result, the identification result, and the open/closed state of the eyes from the personal identification unit 26 are notified to the control unit 18.

The control unit 18 monitors the information sent from the personal identification unit 26. When the image captured by the camera unit 25 does not contain any face images, a time is obtained from the clock unit 28 and measurement of an elapsed time is started by the timer circuit unit 29. When no face image is detected for a certain period of time, the control unit 18 decides that no viewer is present in front of the television, that is, no one is watching the television, and the control unit 18 turns off the television monitor 15 to enter a power saving mode for reducing power consumption. After that, when a face image is detected again, the control unit 18 turns on the television monitor 15 to enter a normal operation mode. If the detected face image is identical to a previously detected face image, a program is reproduced by the recording/reproducing apparatus 40 from a time when the face image was not detected.

In the case where the face image is detected again within the certain period of time, the control unit 18 causes the timer circuit unit 29 to stop the measurement of an elapsed time.

As previously mentioned, the broadcast signal receiving system of the patent document determines the presence or absence of a viewer in front of the television monitor 15 by using the camera unit 25. When the absence of a viewer is determined, the broadcast signal receiving system enters the power saving mode after the certain period of time, reducing excessive power consumption.

### DISCLOSURE OF THE INVENTION

In the broadcast signal receiving system of the related art, however, power still is consumed by the operations of the control unit 18 and the recording/reproducing apparatus 40 even when the television monitor 15 enters a power saving state. In order to minimize the power consumption, it is preferable that a user frequently turns off the broadcast signal receiving system (television). Thus it is considered that the user may be encouraged frequently to turn on and off the broadcast signal receiving system. However, such a proposal has not been made.

Further, it is assumed that the broadcast signal receiving system of the patent document is a television at home, but such a broadcast signal receiving system may be installed in a different environment. For example, in recent years, display devices having large screens are installed in public places such as a station square and gathering places to display advertising video. However, on such a display device, it is not possible to confirm whether or not an audience views (watches) the display device, whether or not the display device is efficiently viewed, or whether or not effective advertisements are provided.

The present invention has been devised to solve the problem. An object of the present invention is to provide a display device that makes it possible to confirm whether the display device is efficiently used (viewed) or not.

In order to solve the problem, a display device or a display method according to the present invention monitors a user of the display device and records a time period during which the display device or a display system is operated but the display device is not viewed.

The present invention makes it possible to record whether the display device is used efficiently or not. Thus it is possible to provide a display device that makes it possible to confirm whether the display device is used efficiently (viewed) or not.

### BRIEF DESCRIPTION OF THE DRAWINGS

FIG. 1 is a block diagram showing the configuration of a digital television according to a first embodiment of the present invention;

FIG. 2 shows viewing information managed by a viewing information managing unit of the digital television according to the first embodiment;

FIG. 3 is a flowchart showing the creation of the viewing information managed by the viewing information managing unit of the digital television according to the first embodiment;

FIG. 4 shows an example of display (the viewing information displayed monthly) on a video signal display unit of the digital television according to the first embodiment of the present invention;

FIG. 5 shows another example of display (the viewing information displayed weekly) on the video signal display unit of the digital television according to the first embodiment of the present invention;

FIG. 6 shows another example of display (the viewing information displayed weekly for a specific viewer) on the video signal display unit of the digital television according to the first embodiment of the present invention;

FIG. 7 shows another example of display (the viewing information displayed daily for the specific viewer) on the video signal display unit of the digital television according to the first embodiment of the present invention;

FIG. 8 shows another example of display (time-line display of the viewing information about the specific viewer) on the video signal display unit of the digital television according to the first embodiment of the present invention;

FIG. 9 is a block diagram showing the configuration of a large display device according to a second embodiment of the present invention;

FIG. 10 shows an example of the attributes, advertisement types, and time periods of viewers who watch the large display device according to the second embodiment;

FIG. 11 shows viewing information managed by a viewing information managing unit of the large display device according to the second embodiment;

FIG. 12 is a flowchart showing the creation of the viewing information managed by the viewing information managing unit of the large display device according to the second embodiment; and

FIG. 13 is a block diagram showing the configuration of a broadcast signal receiving system including a camera of the related art.

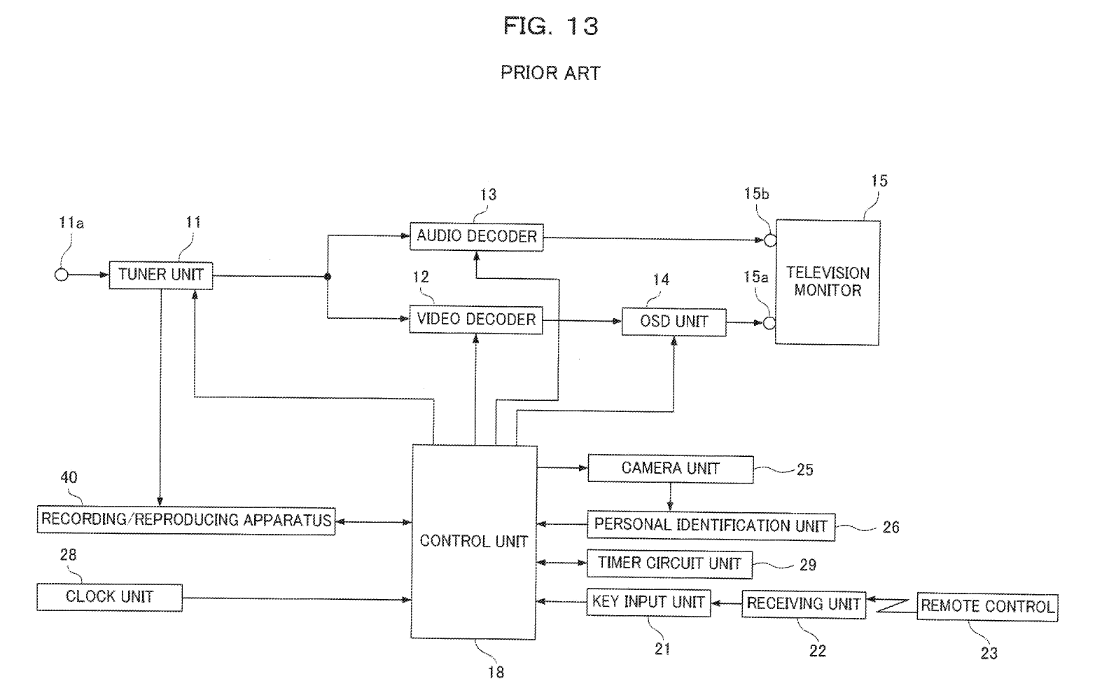

### DESCRIPTION OF THE EMBODIMENTS

The following will describe embodiments of the present invention in accordance with the accompanying drawings.

### First Embodiment

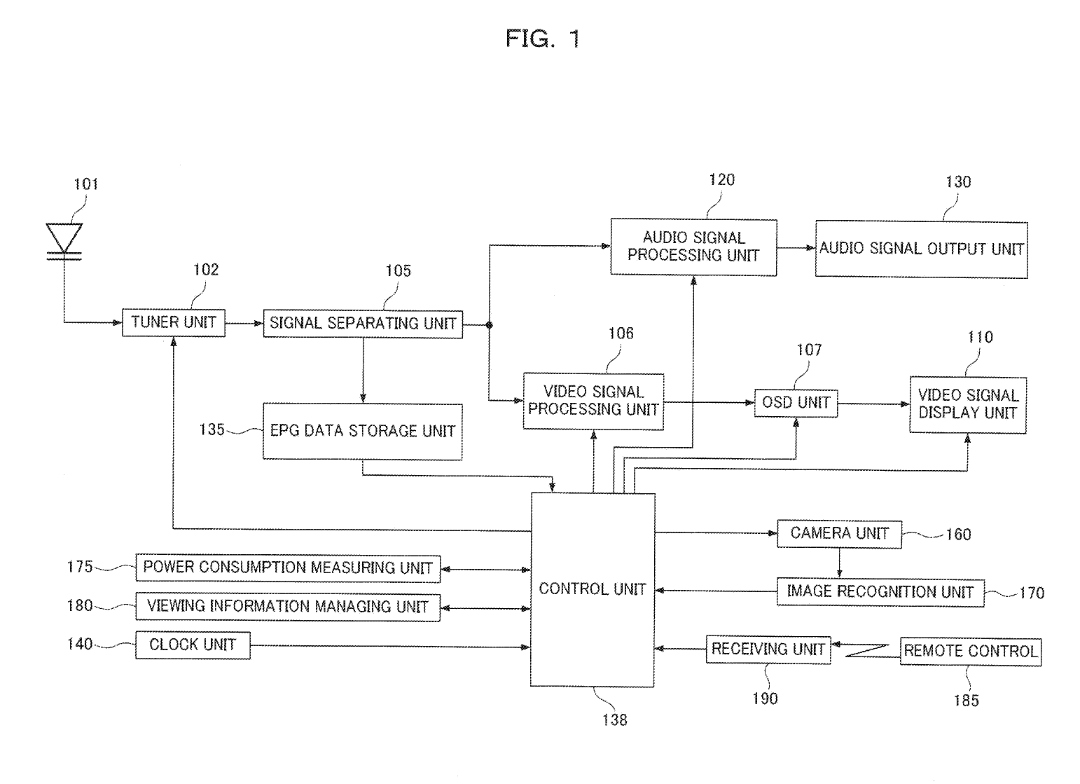

FIG. 1 is a block diagram showing a digital television as an example of a display device according to a first embodiment of the present invention.

As shown in FIG. 1, the digital television as an example of a display device includes: a video signal display unit 110 acting as a display for displaying video; a camera unit 160 acting as an imaging device that images a region opposed to the video signal display unit 110, that is, a region in front of the video signal display unit 110 for displaying video to be viewed by a viewer, and generates image data; an image recognition unit 170 acting as a detector for detecting a viewer in an image of the image data generated by the camera unit 160; a control unit 138 acting also as a measuring device for measuring a non-viewing time during which the video signal display unit 110 displays video and the detector does not detect any viewers; and a viewing information managing unit 180 having a recording device such as a nonvolatile memory for recording the measured time. Further, the digital television includes an EPG data storage unit 135 acting as a video information obtaining device for obtaining information about video displayed on the video signal display unit 110, and a power consumption measuring unit 175 acting as a power consumption measuring device for measuring non-viewing power consumption in the non-viewing time. Moreover, the digital television includes an antenna 101, a signal separating unit 105, an audio signal processing unit 120, an audio signal output unit 130, a video signal processing unit 106, an on-screen display (OSD) unit 107, a remote control 185, and a receiving unit 190.

The image recognition unit 170 acts as a face detector for detecting a face image from an image of the image data generated by the camera unit 160, which is an imaging device, a personal identification device for identifying a person (identifying a viewer), and a decision device for deciding whether or not a viewer views video displayed on the video signal display unit 110. The control unit 138 measures, for example, a non-viewing time while continuously receiving times from a clock unit 140. The control unit 138 also acts as an extracting device for extracting the attributes (including personal information) of viewers and a charge converter for converting non-viewing power consumption into a charge.

Referring to FIG. 1, the constituent elements of the digital television will be described in detail below.

In FIG. 1, the antenna 101 receives broadcast waves. A tuner unit 102 selects a desired channel from the broadcast waves received by the antenna 101 and demodulates the channel to a digital broadcast signal. The signal separating unit 105 extracts a broadcast multiplexed signal from the channel selected by the tuner unit 102 and separates a video signal, an audio signal, and electric program guide (EPG) data that is program information. The video signal processing unit 106 decodes a signal stream of video signals separated by the signal separating unit 105 and reproduces a decompressed digital video signal. The OSD unit 107 superimposes display signals such as a channel number on the output of the video signal processing unit 106. The video signal display unit 110 typically includes a display panel such as a plasma display panel or a liquid crystal display panel and a controller for controlling the display panel. The video signal display unit 110 converts the digital video signal from the OSD unit 107 into an analog video signal and displays the signal on the display panel.

The audio signal processing unit 120 decodes a signal stream of audio signals separated by the signal separating unit 105, and outputs a digital audio signal. The audio signal output unit 130 is a speaker that converts the digital audio signal from the audio signal processing unit 120 into an analog audio signal and outputs the signal. The electric program guide (EPG) data extracted by the signal separating unit 105 is stored in the EPG data storage unit 135 and is referred from the control unit 138 as needed. The clock unit 140 notifies the control unit 138 of the current time. The camera unit 160 is installed so as to image a region in front of the video signal display unit 110, that is, a viewer of the digital television. An image captured by the camera unit 160 is inputted to the image recognition unit 170. The image recognition unit 170 detects a face image from the captured image and performs personal identification to identify the detected face image. The face detection result and the personal identification result are notified to the control unit 138. The control unit 138 includes a CPU (not shown) and a memory including ROM and RAM.

Various techniques are known as face detection techniques. For example, P. Viola and M. Jones announced a face image learning technique using boosting. Personal identification is also known processing in which feature quantities such as a distance between eyes and a nose position are registered beforehand from a viewer's face image captured by the camera unit 160, the feature quantities are compared with the feature quantities of a face image detected from the current image, and it is decided whether or not the detected face image matches the registered face image.

The power consumption measuring unit 175 is connected to a power supply (not shown) for supplying power to the digital television, and measures the power consumption of the digital television of FIG. 1 in real time.

The viewing information managing unit 180 collectively stores the image recognition result from the image recognition unit 170, the EPG data information from the EPG data storage unit 135, and power consumption information measured for the digital television by the power consumption measuring unit 175. The viewing information managing unit 180 also includes a nonvolatile memory, so that the stored information is not deleted even if the digital television of the present embodiment is turned off.

The remote control 185 has buttons for operating the digital television of the present embodiment. The input of the remote control 185 is transmitted to the receiving unit 190 using infrared rays or the like. In the receiving unit 190, a received signal is converted to an operation command for the digital television and is sent to the control unit 138.

The following will describe the operations of the digital television configured thus.

First, when the digital television is turned on by the remote control 185, broadcast waves received by the antenna 101 are inputted to the signal separating unit 105 through the tuner unit 102, and the EPG data and the video signal and the audio signal of a program, which corresponds to a channel number inputted from the remote control 185, are separated from the broadcast multiplexed signal. The video signal is decoded through the video signal processing unit 106. After OSD display is superimposed on the video signal by the OSD unit 107, the signal is displayed on the video signal display unit 110; meanwhile, the audio signal separated from the broadcast multiplexed signal by the signal separating unit 105 is decoded in the audio signal processing unit 120 and is outputted as sound from the audio signal output unit 130. The EPG data is stored in the EPG data storage unit 135 from the signal separating unit 105. The series of operations is similar to that of a typical digital television. In the present embodiment, the camera unit 160 captures an image in front of the digital television, based on which it is determined whether or not a viewer is viewing a program displayed on the digital television, and the determination result is stored in the viewing information managing unit 180 with the power consumption information of the power consumption measuring unit 175.

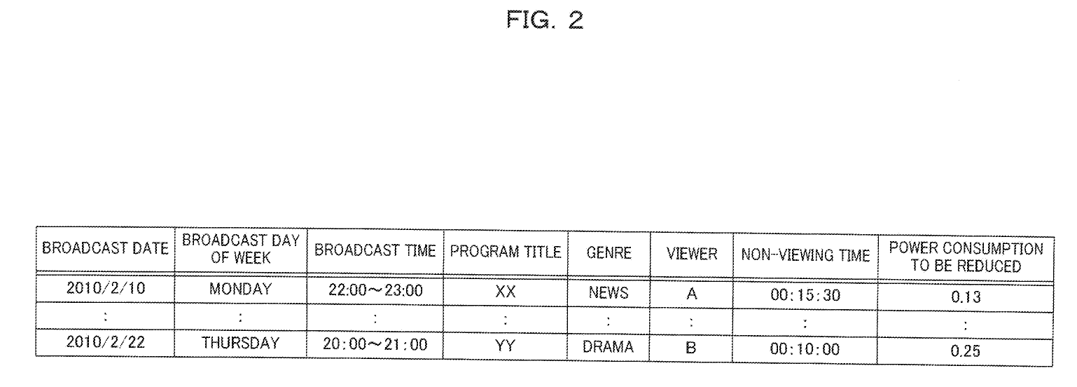

FIG. 2 shows viewing information managed by the viewing information managing unit 180. In the present embodiment, the viewing information is managed in a table as shown in FIG. 2. A record is composed of a broadcast date, a broadcast day of the week, a broadcast time, a program title, a genre, a non-viewing time, and power consumption to be reduced. The broadcast day and date, the broadcast time, the program title, and the genre are information obtained from the EPG data storage unit 135. The non-viewing time is a time period during which an image of the camera unit 160 is subjected to face detection in the image recognition unit 170 but no faces (face images) are detected, that is, a time period during which a program is displayed on the digital television but the contents are not viewed by any viewers. The power consumption to be reduced is the power consumption of the digital television in the non-viewing time. A viewer is a person who watches the digital television until just before the non-viewing time, and the person is identified by personal identification in the image recognition unit 170.

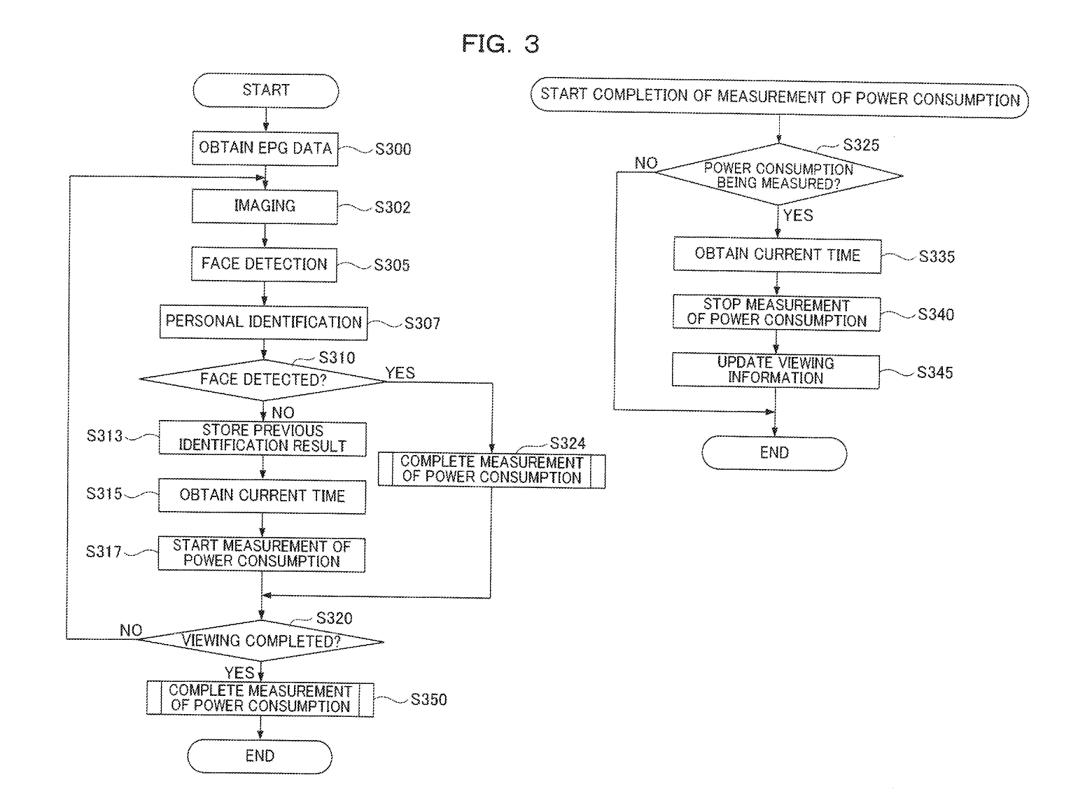

The flowchart of FIG. 3 shows processing performed when the digital television is turned on, when one channel is tuned to another by the remote control 185, or when the current program ends and another program starts. First, in step S300, the control unit 138 obtains the program information of a currently selected channel from the EPG data storage unit 135. Next, in step S302, the camera unit 160 images a state of a space in front of the digital television. In step S305 following step S302, face detection is performed on an image of the camera unit 160 by the image recognition unit 170. In personal identification in step S307 following the face detection of S305, the feature quantities of a face image detected in the face detection of step S305 are compared with the feature quantities of stored viewer faces and it is decided who is viewing the digital television. Next, in step S310, it is decided whether a face is present or not, that is, whether a face has been successfully detected or not. When the face detection has failed, that is, when the number of detected faces is zero, the process advances to step S313 and the name of the last viewer identified in the personal identification of step S307 is stored on a memory (not shown) provided in the control unit 138. Next, in step S315, the control unit 138 obtains the current time from the clock unit 140. In step S317 following step S315, the control unit 138 instructs the power consumption measuring unit 175 to start measuring power consumption. The power consumption measuring unit 175 starts measuring the power consumption of the digital television in response to the instruction of the control unit 138. After the measurement of power consumption is started in step S317, the process advances to step S320.

In step S310, when a face is detected in the face detection performed on the image of the camera unit 160 by the image recognition unit 170, the process advances from step S310 to step S324. In step S324, the measurement of power consumption is completed.

Step S324 for the completion of the measurement of power consumption is composed of multiple steps. Specifically, first in step S325, it is decided whether power consumption is being measured or not. When it is decided that power consumption is not being measured, the process exits. When it is decided that power consumption is being measured, the process advances to step S335. In step S335, the control unit 138 obtains the current time from the clock unit 140. Next, in step S340, the control unit 138 instructs the power consumption measuring unit 175 to complete the measurement of power consumption. The power consumption measuring unit 175 completes the measurement of power consumption of the digital television in response to the instruction of the control unit 138, and notifies the control unit 138 of the measurement result of power consumption. After that, in step S345, the viewing information of the viewing information managing unit 180 is updated. To be specific, another record is created by the control unit 138 based on EPG data obtained in step S300 so as to contain a broadcast date, a broadcast day of the week, a broadcast time, a program title, and a genre, a non-viewing time that is a difference between two pieces of time information obtained in steps S315 and S335, and power consumption obtained in step S340, and the record is notified to the viewing information managing unit 180. The viewing information managing unit 180 searches for records matching the broadcast date, the broadcast day of the week, the broadcast time, the program title, and the genre. If there is a match, the non-viewing time of the record notified from the control unit 138 is added to the non-viewing time of the retrieved record and power consumption to be reduced in the record notified from the control unit 138 is added to power consumption to be reduced in the retrieved record. If there is no match, the record notified from the control unit 138 is added to the viewing information of the viewing information managing unit 180.

In step S320, it is decided whether the running of the current program should be terminated or not. To be specific, when the digital television is turned off, when one channel is tuned to another by the remote control 185, or when the broadcasting of the current program ends and the subsequent program starts, the process advances to step S350 along YES; otherwise the process returns to step S302 and an image is captured by the camera unit 160 again.

In step S350, the measurement of power consumption is completed as in step S324 and the explanation thereof is omitted.

The storage of the viewing information was described according to the flow chart of FIG. 3.

The processing of the flowchart of FIG. 3 creates the viewing information records about programs displayed on the digital television, in the viewing information managing unit 180 as shown in FIG. 2.

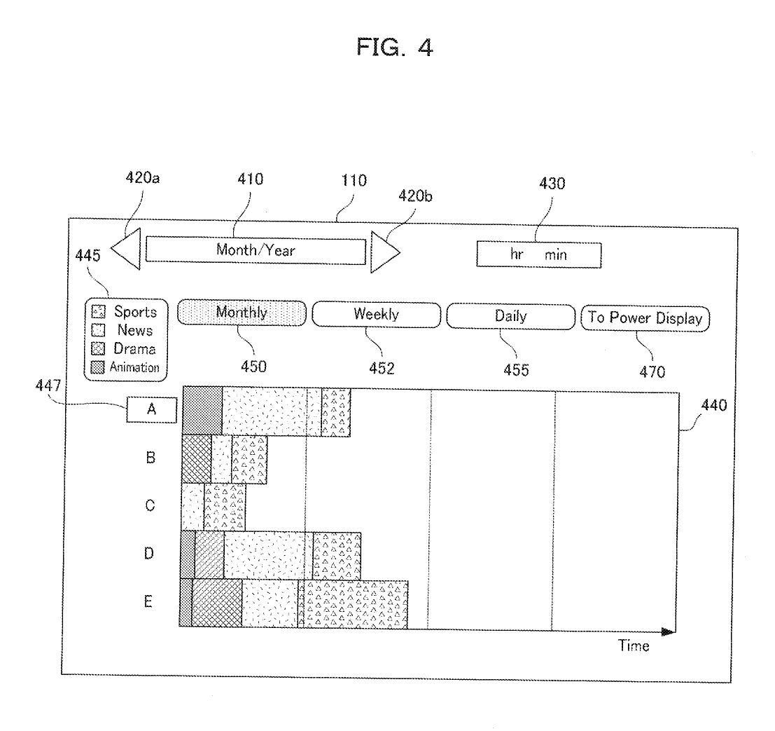

FIG. 4 shows an example of display provided by the video signal display unit 110 based on the viewing information stored in the viewing information managing unit 180. FIG. 4 is a graph showing the non-viewing times of viewers in a month. In FIG. 4, a period display part 410 indicates a year and a month to be displayed on the graph. The target month can be changed by selecting an arrow 420a and an arrow 420b with the remote control 185. A total display part 430 indicates the total non-viewing time of the month indicated by the period display part 410. In a graph display region 440, the non-viewing times of the viewers on the digital television are shown for the month displayed in the period display part 410. The graph in the graph display region 440 is a stacked bar chart in which non-viewing times are summed for each program genre contained in the EPG data. The correspondence between the display of the stacked bar chart and the program genres is displayed in a genre display part 445. Further, one of the viewer names displayed in the graph display region 440 can be selected by a cursor 447 operated by the remote control 185. When one of the viewers is selected by the remote control 185, a non-viewing time or power consumption to be reduced can be displayed for the viewer on the video signal display unit 110, as will be described later.

A monthly display button 450 is a button for switching a display period to a month. In FIG. 4, the monthly display button 450 has been pressed. A weekly display button 452 is a button for switching the display period to a week. A daily display button 455 is a button for switching the display period to a day. A unit switching button 470 is a button for toggling the display unit of the graph display region 440 to times or power consumption. In FIG. 4, the total display part 430 and the graph display region 440 are expressed in times and thus the unit switching button 470 indicates “to power display”. When the total display part 430 and the graph display region 440 are expressed in power, the unit switching button 470 indicates “to time display”.

The control unit 138 calculates numeric values required for the information display of FIG. 4, from the viewing information stored in the viewing information managing unit 180. Specifically, the total display part 430 extracts records matching a period displayed in the period display part 410, from the viewing information managing unit 180, and the non-viewing times of the extracted records are summed. Moreover, numeric values required for the display of the graph display region 440 can be determined by grouping the extracted records by viewer and program genre and summing the non-viewing times for each group.

The control unit 138 creates the values of the total display 430 and the graph display region 440 from the viewing information stored in the viewing information managing unit 180. Further, the control unit 138 issues various screen display commands to the OSD unit 107 and controls the OSD unit 107 so as to provide display on the video signal display unit 110 as shown in FIG. 4.

In FIG. 4, when the unit switching button 470 is selected and pressed by the remote control 185, power consumption to be reduced is displayed in the total display part 430 and the graph display region 440. Specifically, the total display part 430 extracts records matching a period displayed in the period display part 410 and calculates the final value of power consumption to be reduced, by summing power consumption to be reduced in the extracted records. In the graph display region 440, the extracted records are grouped by viewer and program genre and data required for displaying the graph is determined by summing the power consumption to be reduced in each group.

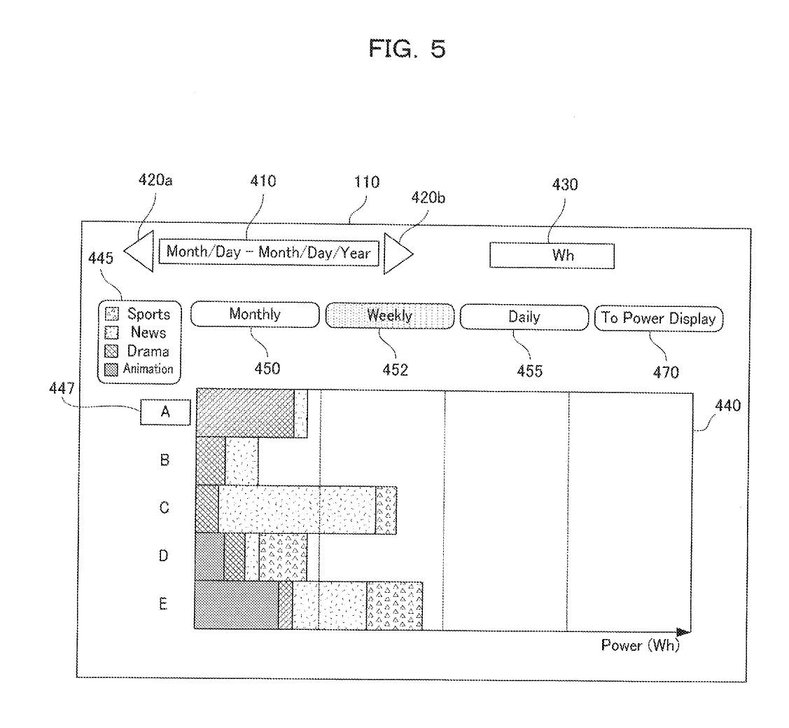

FIG. 5 shows a display example when the weekly display button 452 is selected and pressed by the remote control 185 in FIG. 4. In FIG. 5, the non-viewing times of a specific week are summed for each viewer and are displayed on the video signal display unit 110. The same constituent elements as in FIG. 4 are indicated by the same reference numerals and the explanation thereof is omitted.

In FIG. 5, the period display part 410, in which a month has been displayed in FIG. 4, indicates a currently selected week. The total display part 430 indicates the total power consumption to be reduced by all the viewers in the week displayed in the period display part 410. The graph display region 440 indicates a graph of power consumption to be reduced for each viewer in the week displayed in the period display part 410. In FIG. 5, the value of the total display part 430 and the non-viewing times of the graph display region 440 are calculated by the control unit 138 that sums, in a specified period, the viewing information stored in the viewing information managing unit 180, as in the creation of screen display contents shown in FIG. 4.

When the daily display button 455 is selected and pressed (not shown) by the remote control 185 in FIG. 4 or 5, the period display part 410 indicates a specific date. The total display part 430 indicates non-viewing times or power consumption to be reduced for all the viewers on the date indicated in the period display part 410. The graph display region 440 indicates non-viewing times or power consumption to be reduced for the respective viewers on the date indicated in the period display part 410.

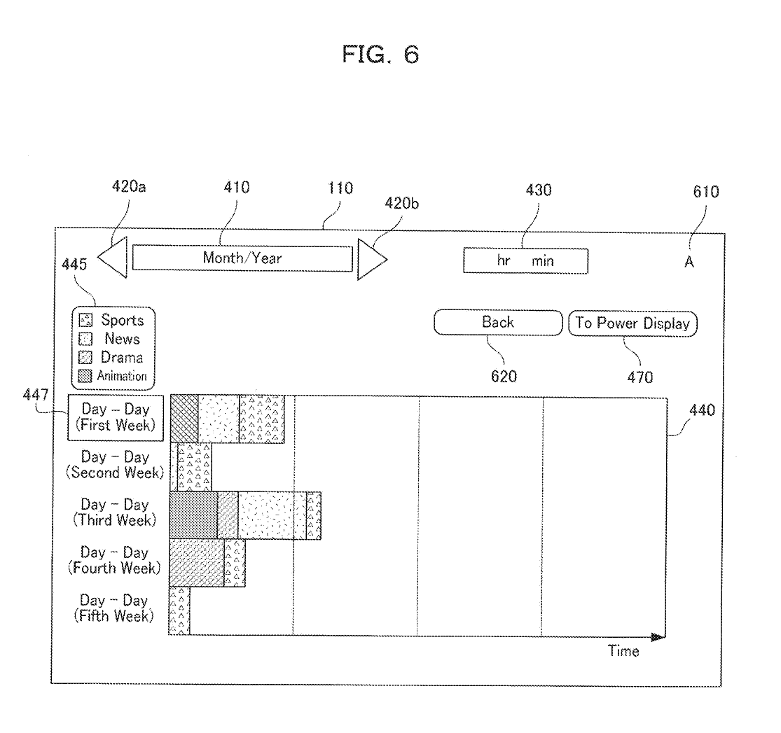

FIG. 6 shows a display example of the video signal display unit 110 based on the viewing information stored in the viewing information managing unit 180 when one of the viewers is selected and pressed by the cursor 447 operated by the remote control 185 in FIG. 4. In FIG. 6, the same constituent elements as in FIG. 4 are indicated by the same reference numerals and the explanation thereof is omitted.

In FIG. 6, a viewer display region 610 indicates the viewer's name (A in FIG. 6) selected by the cursor 447 in FIG. 4. Regarding the viewer displayed in the viewer display region 610, non-viewing times for each week of the month of the period display part 410 are displayed in the graph display region 440. When a back button 620 is selected and pressed by the remote control 185, the display returns to the screen display of FIG. 4.

The control unit 138 calculates numeric values required for the information display of FIG. 6, from the viewing information stored in the viewing information managing unit 180. Specifically, the total display part 430 extracts records matching a period displayed in the period display part 410 and the viewer displayed in the viewer display region 610, from the viewing information managing unit 180, and the non-viewing times of the extracted records are summed. Moreover, numeric values required for the display of the graph display region 440 can be determined by grouping the extracted records by week and program genre and summing the non-viewing times for each group.

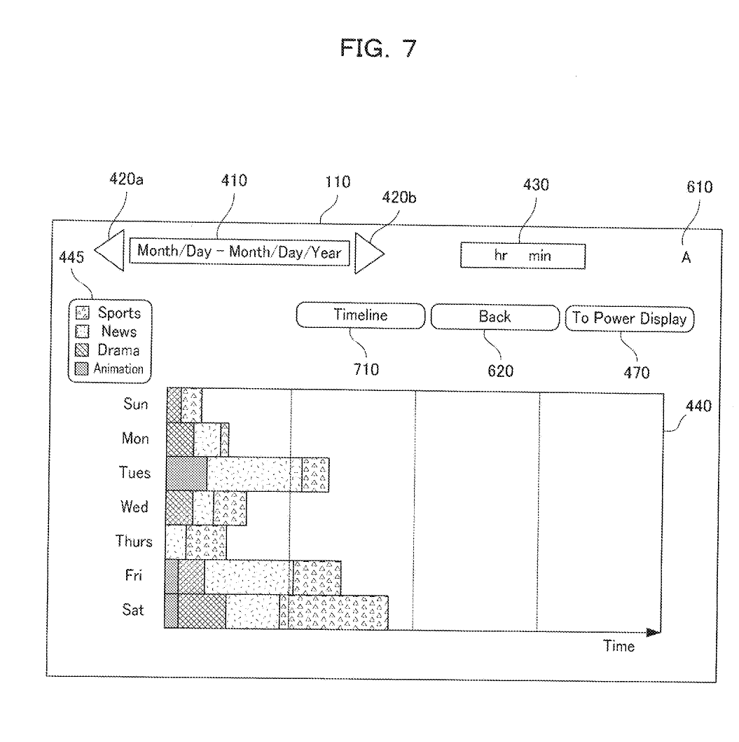

In FIG. 6, the cursor 447 can select weeks displayed in the graph display region 440. FIG. 7 shows a display example when a week pointed by the cursor 447 is selected and pressed by the remote control 185. In FIG. 7, the same constituent elements as in FIG. 4 are indicated by the same reference numerals and the explanation thereof is omitted.

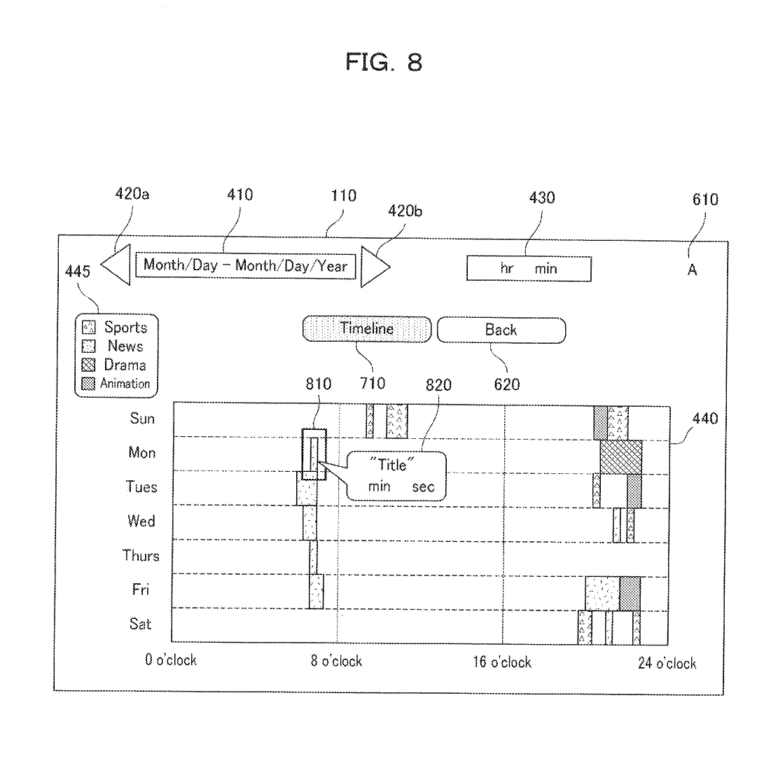

In FIG. 7, regarding the viewer displayed in the viewer display region 610, the total display part 430 displays the total non-viewing time of the week displayed in the period display part 410, and the graph display region 440 displays non-viewing times for the respective days of the week displayed in the period display part 410. As in FIGS. 4 to 6, the graph display region 440 displays a stacked bar chart with each program genre. In the display example of FIG. 7, a timeline switching button 710 is provided for switching display formats in FIG. 7. When the timeline switching button 710 is selected and pressed by the remote control 185, the screen display of FIG. 8 is provided on the video signal display unit 110.

In FIG. 8, regarding the viewer displayed in the viewer display region 610, the total display part 430 displays the total non-viewing time of the week displayed in the period display part 410, and non-viewing times are displayed in a timeline for the respective days of the week displayed in the period display part 410. In FIG. 8, the same constituent elements as in FIGS. 4 and 6 are indicated by the same reference numerals and the explanation thereof is omitted.

In FIG. 8, the timeline switching button 710 has been pressed. By pressing the timeline switching button 710 again, the display can be switched to the display of FIG. 7. A non-viewing time region in the graph display region 440 can be selected by a cursor 810 operated by the remote control 185. Information about the non-viewing time region selected by the cursor 810 is displayed in a detailed information part 820. The detailed information part 820 displays a program title and the duration of the program. As in the display examples of FIGS. 4 to 7, the control unit 138 calculates numeric values required for the information display of FIG. 8, from the viewing information stored in the viewing information managing unit 180.

As a modification of the present embodiment, for example, a read-only memory (ROM), which is provided in the control unit 138 but is not shown specifically, may contain a conversion rate for power consumption and a charge amount and displayed power consumption to be reduced may be converted to a charge amount. In the screen displays of FIGS. 5 to 8, only a time or power is displayed for a non-viewing period. The total viewing time of the digital television and the total power consumption of the total viewing time of the digital television also may be displayed to recognize a ratio of a non-viewing time to the total viewing time of the digital television and a ratio of power consumption to be reduced to the total power consumption of the digital television.

By using the digital television (display device) configured thus and the display method, it is possible to monitor whether or not a user is viewing the display contents of the display device, and present the display time of the display device or the power consumption of the display time when the user is not viewing the display contents of the display device. In other words, it is possible to notify the user of whether the digital television is used efficiently or not, e.g., the ratio of the non-viewing time, genres and viewers with a long non-viewing time, and the ratio of power consumption, thus encouraging the user to frequently turn on and off the display device and raising awareness of power saving. Further, it is possible to turn on the display device of the digital television only when necessary, achieving efficient use of the display device and further reducing excessive energy consumption.

The preferred embodiment of the present invention has been discussed. Needless to say, the present invention is not limited to the present embodiment and various modifications can be made without departing from the scope of the invention. Particularly, various modifications can be made on the display format of the graph displayed on the video signal display unit 110, a user interface including the layout and types of the buttons, and the viewing information stored in the viewing information managing unit 180. Further, information display methods other than graphs can be used without causing any problems. For example, a non-viewing time or power consumption to be reduced may be superimposed on a channel guide, in which EPG data is displayed, to easily recognize a program being viewed while a viewer does other things.

Various known methods are available for face detection and personal identification. However, the present invention does not depend on the type of technique.

In the present embodiment, the camera unit 160 captures an image to decide whether or not a viewer is watching the digital television. Further, an open/closed state of eyes may be detected by a high-resolution camera. Thus even when the face of a viewer is detected, it is determined that the viewer with closed eyes has fallen asleep and has not watched the digital television, so that the detection time may be regarded as a non-viewing time. Moreover, the positions of pupils may be detected in addition to the face to detect the line of viewer's sight, so that it is possible to decide whether or not the viewer is watching the digital television.

In the present embodiment, the single camera unit 160 is provided. Multiple cameras may be used to increase the accuracy of face detection. Further, the camera of the present invention is not limited to a camera capable of imaging visible radiation. A camera capable of imaging infrared radiation may be used to increase the accuracy of face detection at a low light intensity.

In the present embodiment, it is decided that a viewer is present when a face image is detected. The present invention is not limited to the decision method. For example, the presence or absence of a person is first determined from captured images (including an image captured by a camera capable of imaging infrared radiation) or an infrared sensor provided separately, and then information about the presence or absence of a person is obtained. In this state, when the presence of a person is decided, the viewing state of the person is detected based on face detection, an open/closed state of eyes, the line of sight, and so on. The presence of a person may be decided at the detection of a face, opened eyes, or a line of sight.

In the present embodiment, the viewing information is created only for a currently broadcast program. Viewing information may be created for programs recorded by a recorder connected to the digital television or recorded on a hard disk drive (HDD) contained in the main unit of the digital television. When recording is reserved in the recorder and the main unit of the digital television, EPG information on programs to be reserved is stored, so that as in the present embodiment, viewing information can be created for viewing recorded programs.

In the present embodiment, the viewing information is created only for the single digital television provided for multiple family members. The number of display devices is not particularly limited and multiple display devices may be connected on a LAN to transmit and receive information. Viewing information may be collected on the display devices and the viewing information collectively displayed on the display devices does not cause any problems.

In the present embodiment, power measurement is started when no faces are detected by imaging of the camera unit 160. Power measurement may be started after no faces have been detected for a certain period of time. After no faces have been detected for the certain period of time, power measurement may be started when the digital television having the function of entering a power saving mode enters the power saving mode.

In the present embodiment, the display device is a digital television. Needless to say, the present invention is applicable to various other display devices such as a PC monitor.

### Second Embodiment

In the first embodiment, the display device is a digital television provided for multiple family members. The present invention is not limited to this installation environment. In a second embodiment, the installation environment is different from that of the first embodiment. The second embodiment describes an example in which a display device having a large screen (also called a large display device) is installed in public places such as a station square and gathering places. The large display device sequentially displays (outputs), e.g., advertising video with sound.

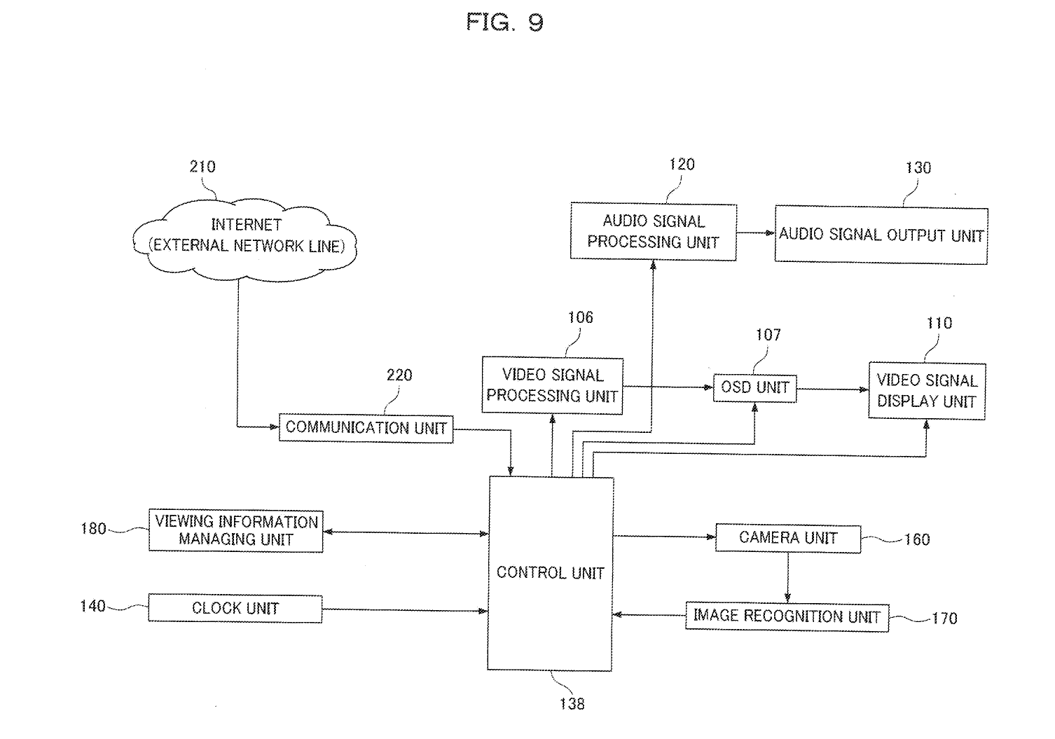

FIG. 9 is a block diagram showing the large display device as an example of a display device according to the second embodiment of the present invention. The constituent elements having the same functions as those of the digital television according to the first embodiment of the present invention are indicated by the same reference numerals.

As shown in FIG. 9, the large display device as an example of a display device includes: a video signal display unit 110 acting as a display for displaying video; a camera unit 160 acting as an imaging device that images a region opposed to the video signal display unit 110, that is, a region in front of the video signal display unit 110 for displaying video to be viewed by viewers, and generates image data; an image recognition unit 170 acting as a detector for detecting viewers in an image of the image data generated by the camera unit 160; a control unit 138 acting also as a measuring device for measuring a non-viewing time during which the video signal display unit 110 displays video and the detector does not detect any viewers; and a viewing information managing unit 180 having a recording device, e.g., a nonvolatile memory for recording the measured time. The large display device further includes a communication unit 220 for communication with an external network line such as an internet 210, an audio signal processing unit 120, an audio signal output unit 130, a video signal processing unit 106, and an on-screen display (OSD) unit 107. The camera unit 160 may be composed of multiple cameras.

The image recognition unit 170 acts as a face detector for detecting a face image from an image of the image data generated by the imaging device, a personal identification device for identifying a person (identifying a viewer), and a decision device for deciding whether or not a viewer is viewing video displayed on the video signal display unit 110. The control unit 138 also acts as an extracting device for extracting the attributes (sex and age) of a viewer and measures a non-viewing time for each of the attributes while continuously receiving times from a clock unit 140.

Referring to FIG. 9, the constituent elements of the large display device will be described below.

In FIG. 9, the communication unit 220 communicates with an external network line such as the internet 210 to receive advertising video and advertisement type information corresponding to the advertising video. The control unit 138 recognizes a video signal and an audio signal, which correspond to the advertising video, and information about the advertising video, from signals inputted from the communication unit 220, and the control unit 138 separates the signals and the information. The video signal processing unit 106 converts a signal stream of video signals inputted from the control unit 138 through the communication unit 220, and reproduces a digital video signal. The OSD unit 107 superimposes various display signals of, e.g., the advertising type information on the output of the video signal processing unit 106 when necessary. The video signal display unit 110 typically is made up of a screen device including a projector, a display unit such as a plasma display panel or a liquid crystal display panel, and a controller for controlling the display unit. The video signal display unit 110 converts the digital video signal, which is outputted from the OSD unit 107, into an analog video signal and displays the signal on the display panel.

The audio signal processing unit 120 converts the signal outputted from the control unit 138 through the communication unit 220, into a digital audio signal and outputs the signal. The audio signal output unit 130 is a speaker for converting the digital audio signal inputted from the audio signal processing unit 120 into an analog audio signal and outputting the signal. Moreover, information about the inputted advertising video is stored in a storage unit (recording unit) (not shown) provided in the control unit 138 and is referred in the storage unit. The clock unit 140 notifies the control unit 138 of the current time. The camera unit 160 is installed so as to image a region in front of the video signal display unit 110 and images a person in the region in front of the video signal display unit 110. An image captured by the camera unit 160 is inputted to the image recognition unit 170. In the image recognition unit 170, a face image is detected from the captured image and the sex and age of the person (regarded as a viewer when a face image is detected) are extracted as attributes from the detected face image. The control unit 138 includes a CPU and memory such as ROM and RAM, which are not shown. The control unit 138 can send the information obtained through the communication unit 220, to advertising agencies and clients who are contracted with the installed large display device.

The following will describe the operations of the large display device configured thus.

First, the control unit 138 obtains advertising video, audio signal information corresponding to the advertising video, and advertising type information associated with the video and information, through an external network line such as the internet 210 and the communication unit 220. The advertising video is displayed on the video signal display unit 110 and sound for the video is outputted from the audio signal output unit 130. The series of operations is similar to that of a typical digital television. Further, in the present embodiment, the camera unit 160 images a location in front of the large display device, viewers are detected (face image detection), the attributes (sex and age) of the viewers are determined, and it is decided whether or not the viewers are viewing video displayed on the large display device. The decision result is stored in the viewing information managing unit 180.

In other words, when a face image can be detected from an image captured by the camera unit 160, the attributes of a viewer can be recognized from the face image, and the viewer (e.g., “underage male”) can be detected for the attributes, it is decided that the viewer with the attributes is viewing the advertising video. When the person with the attributes (face image) cannot be detected, it is decided that the person is not viewing the advertising video, and the measurement of a non-viewing time is started. When the person with the same attributes (e.g., “underage male”) is detected again, it is decided that the person is viewing the video, and the measurement of the non-viewing time is completed. In this way, the non-viewing time is measured by measuring a time during which a person with certain attributes is not detected.

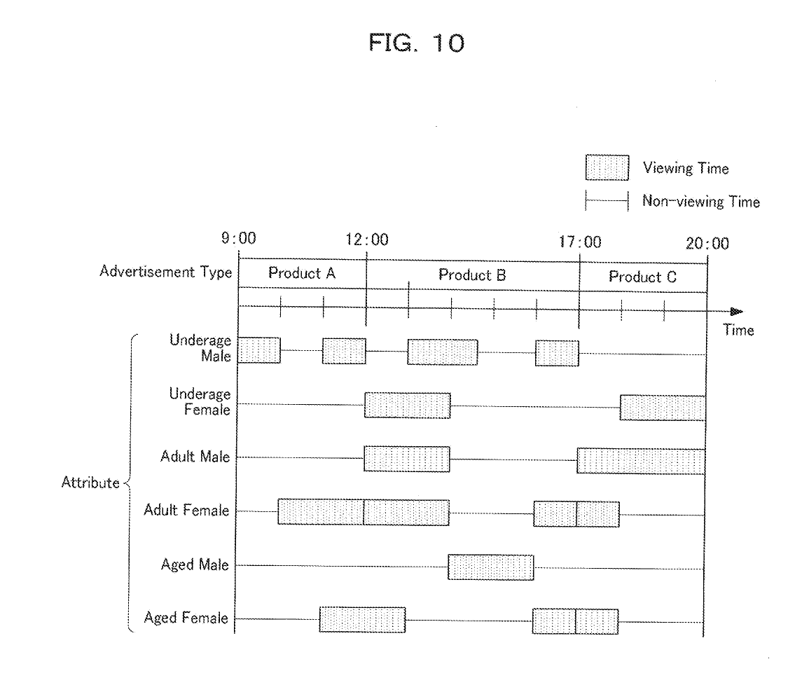

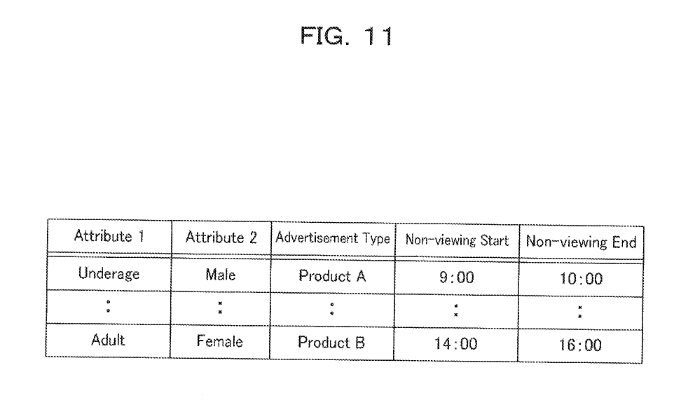

FIG. 10 shows an example of attributes, advertisement types, and time periods for viewers who watch the large display device. FIG. 11 shows an example of viewing information managed by the viewing information managing unit 180. In these examples of FIGS. 10 and 11, the reproduction of the advertising video is started from 9 o'clock and is completed at 20 o'clock. The advertising video of product A is reproduced from 9 o'clock to 12 o'clock, the advertising video of product B is reproduced from 12 o'clock to 17 o'clock, and the advertising video of product C is reproduced from 17 o'clock to 20 o'clock. In FIG. 10, rectangles represent viewing time periods and straight lines represent non-viewing time periods. A viewer is identified from a face image with attribute 1, which is an age (underage, adult, senior), and attribute 2, which is a sex (male or female). In FIG. 10, an underage male viewer views the advertising video of product A from 9 o'clock to 10 o'clock and from 11 o'clock to 12 o'clock.

In the present embodiment, the viewing information is provided in a table as shown in FIG. 11. A record is composed of attribute 1 (age) of a viewer, attribute 2 (sex) of the viewer, an advertisement type, a non-viewing start time, and a non-viewing end time. Preferably, a non-viewing time also is managed as information on the non-viewing start time and the non-viewing end time (not shown). The non-viewing start time and the non-viewing end time are a start time and an end time when face detection is performed on an image of the camera unit 160 by the image recognition unit 170 but any faces (face images) are not detected for attribute 1 (age) and attribute 2 (sex) of viewers. Between the non-viewing start time and the non-viewing end time, the contents of an advertising video program displayed on the large display device are not viewed by viewers having the corresponding attributes.

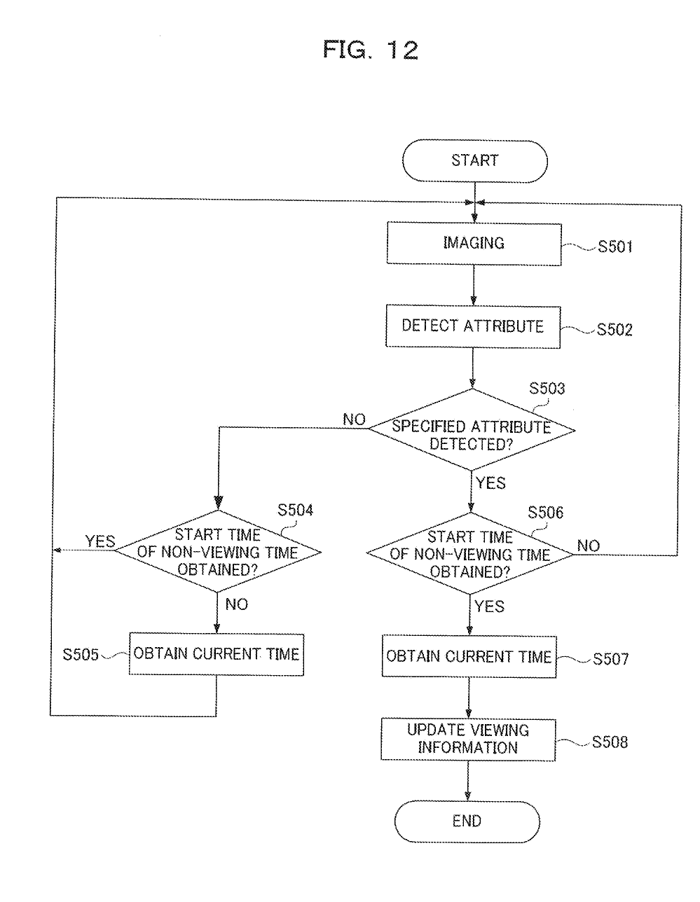

Referring to the flowchart of FIG. 12, the operations of the large display device will be more specifically described below.

First, in step S501, the camera unit 160 images a state of a space in front of the large display device (video signal display unit 110). Next, in step S502, face detection is performed on an image of the camera unit 160 by the image recognition unit 170. When a face image is detected, the image recognition unit 170 acting as a detector detects attributes (age and sex). In step S503 following step S502, the image recognition unit 170 decides whether specified attributes have been detected or not. As shown in FIG. 10, six attributes specified in the present embodiment are “underage male”, “underage female”, “adult male”, “adult female”, “aged male”, and “aged female”. In the following explanation, the specified attribute is “underage male”. The same processing is performed on the other five attributes.

In step S503, when the attribute of “underage male” (an image with the attribute) is not detected (that is, when an “underage male” viewer is not viewing advertising video), the process advances to step S504 and it is confirmed whether the start time of a non-viewing time has been obtained or not. When the start time of a non-viewing time has not been obtained, the process advances to step S505 to obtain the current time and set the start time of a non-viewing time. In step S504, when the start time of a non-viewing time has been obtained, the process returns to step S501.

In step S503, when the attribute of “underage male” (an image with the attribute) is detected (that is, when an “underage male” viewer is viewing advertising video), the process advances to step S506 and it is confirmed whether the start time of a non-viewing time has been obtained or not.

In step S506, when the start time of a non-viewing time has been obtained, it is confirmed that an “underage male” viewer, who has not viewed advertising video, has started viewing the advertising video. In other words, the non-viewing time has been ended. In this case, the process advances to step S507 and the current time is obtained to set the end time of the non-viewing time. By updating the viewing information in step S508, the start time and the end time of the non-viewing time are set (this state is shown in FIG. 11).

In step S506, when the start time of the non-viewing time has not been obtained, it is confirmed that an “underage male” viewer keeps viewing advertising video. Thus the process returns to step S501. Until no “underage male” viewer is detected (until no “underage male” viewer is viewing advertising video), loop processing of step S501→step S502→step S503→step S506→step S501 is continued.

As has been discussed, in the present embodiment, a time when a viewer with specified attributes cannot be detected is extracted as the start time of a non-viewing time and a time when the specified attributes can be detected is extracted as the end time of the non-viewing time, so that the non-viewing time of the person (viewer) with the specified attributes can be measured. Consequently, a client who has requested the display of advertising video can confirm how long a person with the attributes has viewed the advertising video and whether the advertising video has been viewed effectively or not, and confirm the attributes of viewers who have viewed the advertising video, thereby confirming time periods during which the advertising video can be viewed efficiently. Thus it is possible to confirm whether or not the display device of the present embodiment has been used efficiently (viewed), confirm the effectiveness of the advertising video, confirm a difference in the effectiveness of the advertising video between the attributes of viewers (age and sex in the present embodiment), and more efficiently use the advertising video.

In the present embodiment, the advertising video is inputted in communication with external network lines such as the internet 210. The present invention is not limited to an external network line and the advertising video may be inputted from recording media such as a disk on which advertising video has been recorded. In the present embodiment, the attributes of age are “underage”, “adult”, and “aged”. The present invention is not limited to these attributes and the attributes may be “teens”, “20s”, “30s”, . . . .

Further, processing blocks in the block diagrams of FIGS. 1 and 9 showing the digital television are not limited to dedicated hardware. The processing blocks can be implemented by software without causing any problems.

In the present embodiment, it is assumed that viewers watch the digital television that outputs not only images but also sound. The present invention is not limited to such a digital television. In other words, the present invention is similarly applicable to viewers of display devices displaying only video.

The display device or the display method according to the present invention can be used as a display device or a display method that allows a user to view the display contents of the display device.

What is claimed is:

1. A display device comprising:
a display for displaying video;
an imaging device for generating image data by imaging;
a detector for detecting a viewer in an image of the image data generated by the imaging device;
a measuring device for measuring a non-viewing time during which the video is displayed on the display and the detector detects no viewers; and
a recording device for recording the measured time.

2. The display device according to claim 1, wherein the detector is a face detector for detecting a face from the image of the image data generated by the imaging device.

3. The display device according to claim 1, further comprising an extracting device for extracting attributes of the detected viewer,
wherein the measuring device measures the non-viewing time for each viewer specified by the extracted attributes.

4. The display device according to claim 3, further comprising a personal identification device for identifying a person as the extracting device,
wherein the measuring device measures the non-viewing time for each viewer specified by the personal identification device.

5. The display device according to claim 1, further comprising a non-viewing time display for displaying the non-viewing time.

6. The display device according to claim 1, wherein the detector identifies presence or absence of a person in the image of the image data generated by the imaging device, and
when the detector identifies the presence of a person, the detector detects whether or not the person is viewing the display device.

7. The display device according to claim 2, wherein the detector detects not only a face image but also an open/closed state of eyes from the face image, and
the detector detects, as the non-viewing time, a time during which the eyes of the face image are closed in addition to a time during which the image of the image data contains no faces.

8. The display device according to claim 2, wherein the detector detects not only a face image but also a line of sight from the face image, and
the detector detects, as the non-viewing time, a time during which the line of sight is not directed to the display in addition to a time during which the image of the image data contains no faces.

9. The display device according to claim 1, further comprising a power consumption measuring device for measuring a non-viewing state power consumption in the non-viewing time,
wherein the non-viewing state power consumption and the non-viewing time are associated with each other and recorded on the recording device, and
the non-viewing state power consumption is displayed on the display.

10. The display device according to claim 9, further comprising a charge converter for converting the non-viewing state power consumption into a charge,
wherein the charge corresponding to the non-viewing state power consumption is displayed on the display.

11. The display device according to claim 1, further comprising a video information obtaining device for obtaining information about the video displayed on the display,
wherein the information is associated with information about video corresponding to the non-viewing time and is recorded on the recording device.

12. The display device according to claim 1, wherein the viewer has an attribute that is at least one of an age and sex of the viewer.

13. The display device according to claim 1, wherein the display device is located in a gathering place.

14. A display method comprising the steps of:
displaying video;
generating image data by imaging;
detecting a viewer in an image of the image data generated in the imaging step;
measuring a non-viewing time during which the video is displayed on a display and a detector detects no viewers; and
recording the measured time.

15. A program capable of implementing the display method according to claim 14 by means of a computer.

16. A recording medium storing the program according to claim 15, the recording medium being readable by a computer.
